(19) United States
(12) Patent Application Publication
(10) Pub. No.: US 2023/0415011 A1
(43) Pub. Date: Dec. 28, 2023

(54) ROTOBALL

(71) Applicant: NICOLAS GONCHAR, SR., Brea, CA (US)

(72) Inventor: NICOLAS GONCHAR, SR., Brea, CA (US)

(21) Appl. No.: 17/848,718

(22) Filed: Jun. 24, 2022

(51) Int. Cl. A63B 67/00

(52) U.S. Cl. CPC A63B 67/002; A63B 2102/18

(57) ABSTRACT

ROTOBALL is a sport game that depends on the strategy of the placement of defensive infielders and outfielders of varying skill levels into a predetermined and fixed rotation pattern, that is determined by each of the team managers or team captains prior to the onset of the game. The predetermined and fixed rotation pattern (allows for substitutions) and that rotation pattern remains in place for the entirety of the game. The ROTOBALL defensive rotation device displays the placement of each of the defensive players into their positions at the start of each new consecutive inning. The defensive rotation lineup device is a solution in the form of a device; that displays the rotation movement of nine players (and possible substitutions), over the course of a multiple inning of game play and is shared by both teams and the umpire as an officiating device.

### INTRODUCTION

The ROTOBALL defensive rotation device is the end product of a strategy and element in the sport ball game of ROTOBALL. ROTOBALL possesses a similar look, that is well known in both baseball and softball. However, in ROTOBALL the strategy of the team manager and/or team captain is diverted to a strategy of dealing with the players of lesser defensive skills; who are rotated on the onset of each new consecutive inning. In the game of ROTOBALL the team manager or team captain must (as required) engage in the facilitation of a method and strategy of rotating each of their defensive players into a new defensive position. The invention of this defensive rotation line up device and general premise is unique to ROTOBALL.

To state the obvious, in both baseball and softball the managers rely on a single strategy based around their batting personnel, as a potential matchup to what is known in regard to the opposing pitcher. These same batters are fixed (without rotation) at their specialized expertise defensive position(s). In ROTOBALL those specialized expertise defensive positions may not exist or are minimized and overshadowed by a more dominant strategy of rotation; that deals with the positive and negative attributes of each defensive player, as they are rotated into a new defensive position on the onset of each new consecutive inning.

The team manager or team captain fields nine defensive player in the traditional positions of baseball/softball. Traditionally in those sports the defensive players are both experienced and specialized in their prospective defensive positions; and may only know how to play that specific position (throughout the course of their amateur or professional careers). However, in ROTOBALL any advantage in baseball/softball as to specialized defensive players is eliminated by requiring the team manager or team captain to have to or how to strategize play, with lesser specialized players. This deeply affects both the pitcher and catcher positions, as well as the continuity of all of the other positions including batting.

The team manager or team captain must evaluate the defensive players and place them in a sequence, that offers the best defensive result. The team manager or team captain must then choose a rotation pattern for the entirety of the game. The team manager or team captain can rely on patterns offered in FIG. 4, 4a, 5, or 5a or they can create an alternative pattern either known to them or created by them. The general statement regarding sports is that is intended to promote sportsmanship and fun. When the team manager or team captain utilizes a rotation pattern of his own choosing, this is an aspect of fun and creativity. The inventor does not seek to control the team manager or team captain to be limited to any specific pattern or any number of patterns of rotation. However the team manager or team captain is restricted in only being allowed to use one rotation pattern per game. There should not be any criticism of the number of potential rotation patterns, as it is an inherent element of the game.

Once the team manager or team captain has strategized the order of the player's defensive order, the rotation pattern; they then place the result on the ROTOBALL defensive rotation line up device. This is seen as a blank display in FIG. 3 and a filled-out display in FIG. 3a. This device is then posted within the dugout, provided to the opposing team and provided to the umpire who is officiating the game.

ROTOBALL is a new sports ball game in the spirit of the combination of baseball, softball and stickball without the boring and untimely elements that have plagued both the players and the fans alike. Almost every boring element has been removed; along with a series of innovative rules that transform the game of ROTOBALL, into the go to sports ball game of the present and future.

Along with this device, the inventor seeks to provide an explanation of the proper usage of the defensive rotation line up device and other game rules that interact, complement and intertwine with this device/invention.

Both the description below and the diagrams provided (on file), give forth a complete explanation and visual examples of the invention. The game or sport of Baseball has been around since 1845, with several person(s) having their names associated with its creation and rules. Some would argue its perfections or imperfections; and though the Baseball has evolved over the years, it still remains recognizable by the fans and players who have taken it to heart over the last one hundred and fifty years.

What is most obvious and most impressive with higher levels of baseball today, whether it be at the school or professional level; is the specialization of players and the attention and salaries they command. You have your base stealers; your power hitters and you have your pitchers. And though a manager may look like genius, when they put in a multimillion-dollar pitcher in; to shuts down the other team's offensive, it also may look boring or overrated.

Since 1995 to present, Little League signups are down 20%. It is predictable that more kids in third world countries play baseball than in the USA. And the kids in third world countries, have more fun in doing so. Furthermore, though the BASEBALL PARK viewing experience of baseball, still holds many elements of entertainment; viewing it on television is frequently border line boring.

The entertainment of baseball is the sound of the bat, the players on base, dirty uniforms and drama of whether another hit is coming to bring the base runner home. ROTOBALL is an opportunity to loosen up the game and create the moments that are less domaining; and are alternatively left to the frailties of human error and happenstance, by less expensive nonspecialized players.

Some levels of current baseball, see it as a game played by kids for the fun of it; or for the potential future it may bring its youthful players in other countries. At the school and professional levels, it is all about the business, the sport and the chess match. It is dealing with the ins and outs of pitching matchups and the perfection of a batting line, that influences the positioning of the daily players for the defensive fielding.

ROTOBALL adds the additional element (at the higher levels of play), where the manager or team captain; has to deal with the strategies of the positioning of defensive players who are rotated into a new defensive position each inning. This according to a predetermined rotation pattern, assigned at the onset of the game.

ROTOBALL is ideally created to involve a multitude of persons playing together, at various age and skill levels within an appropriate safety level; that can be enjoyed at choose up games at church, family picnics, in school PE class or after school activities. The safety of the game is prescribed by the designation of the ball to be used. ROTOBALL can be carried over into organized youth sports, the public school system and potentially into semi and professional levels.

In years past, some Little League managers sometimes had to play players who were not at all ready; or skilled in baseball fundamentals. These managers would create elaborate ways to put these players in the game, at times where their presences would not harm the team; or these players would be relegated to spend too much time on the bench. ROTOBALL has no control over how a manager or team captain handles their player(s) on the bench; but it does offer players the opportunity to develop potential skills, in each of the positions that they are rotated in, throughout the course of the game.

### SUMMARY

ROTOBALL is an enhanced version of the combination of traditional American baseball, softball and stickball. ROTOBALL has its own set of creative and refined rules, that vary away from the traditional games stated above. 1. The determination of the ball to be used and how it is decided. 2. The rotation of every player each inning in a predetermined pattern. 3. The strategic assignment of defensive players, in that rotation of the predetermined pattern. 4. The assignment of a six-pitch format per at bat; and all the rules governing that at bat. 5. The limitations of how many at bats per inning per team. 6. The determination of the winner of a tied game after six innings at games end (or within the potential to nine innings, if predetermined at the onset of the game).

ROTOBALL, at the truly competitive levels, takes those chess matches to insane levels. This by both affecting the assignment of players for the traditional (offensive) hitting line up; and how the players placement within a new (defensive) position changes each inning.

ROTOBALL is a new game or sport to enhance many of the short comings that plague BASEBALL'S current elements. ROTOBALL is intended to improve the basics of baseball player skills and enhance both the managing, playing and fan viewing experience.

ROTOBALL is a game or sport between two opposing baseball like teams. It is fielded by nine players that have the same field position names as baseball (however the names could be creatively changed); who face an opposing team like themselves, who alternatively within the same inning have the opportunity to field (defensive play) and bat (offensive play). Each inning the defensive players are moved into a new different defensive position in a prescribed set pattern; which is mandatorily maintained throughout the entire six (or to nine innings). There are both basic and creative patterns, that can be utilized by the manager or team captain. Basic math, affords the possibility of nine players in nine positions; being rotated six times, creating fifty-four basic patterns to choose from. However, additional patterns can be created, to extend the number of diagrams to mind-boggling possibilities.

### General Description of Rules

1. The game is played upon a field resembling a traditional baseball field or alternatively an open playing space.
2. Prior to the game, the size of the ball that is going to be used is determined. This can be done by mutual agreement or when a controversy exists (lower levels of play), by the flip of a coin. However, from a practical standpoint, most players do not have baseball equipment that can be easily be used to accommodate all size balls. This decision should be done well in advance, so the team losing the coin toss, is not distracted from having fun. Convenience may dictate, that teams who have a history with a specific ball; seek out other teams with like kind preferences.
3. A manager or team captain, assigns numbers to each of their players and places their numbers on a battling line up sheet, FIG. 2a. A manager or team captain than assigns these numbers to the rotation diagram resembling a basic infield/outfield diagram FIG. 3a. This diagram is the pattern, that this team will have to adhere to throughout the course of the game. Though there will be several universal diagram patterns readily available, the manager or team captain is encouraged to be creative. If a new player is substituted in, they will replace that number. In ROTOBALL there are no multiple position switches, only players being substituted out and lost for the balance of the game. The players being removed from the game will be replaced only by other new players, inserted into that position number (and this can be done at any time, even during at an at bat). The manager or team captain can substitute as many players at a time, based upon the number of their eligible substitutes. Though a player with an assigned number is displayed on the diagram, they cannot be moved out or around of the assigned rotation at any time within that same game. They can only be substituted out of the game. Once a player is substituted out, they cannot be reinserted into the game again; without special permission from the opposing manager or team captain. Example: A player is substituted out and then another player is injured, bringing the team down to less than nine eligible players. It is reasonable to ask to field nine players, however the opposing manager or team captain can refuse.
4. If a player is injured and can not be replaced by a substitute player, because there is no eligible player is available; that number position is removed from the batting order for the duration of the game; and the team is required to play with less players defensively or forfeit. There will be no pitch hitting by an ineligible player. The batting order will be reduced to the exact number of defensive players fielded in the rotation of each inning. If the batting order is reduced to 8 players, the inning can end after 8 at bats according to the rules. This is also true for any number of players less than 8.
5. The only time an ineligible player can be reinserted back into the game, is with the permission of the imposing manager or team captain.
6. If a pitcher in the rotation is ejected and there is no eligible substitute player; and the opposing manager or team captain fails to agree to reassertion of ineligible player to pitch, then the game can be called; and the winner is declared by review of the scorecard. Note, a manager or team captain who is behind on the score; predictable will grant the reinsertion of the ineligible player. However, if this a maneuver by the violating manager or team captain is to “game the system” (by previous usage within a predetermined time period of games); the team will be defaulted and lose regardless of the scorecard.
7. In the first inning, it is apparent what rotation pattern the players are in. Each consecutive inning, those same players move into their new positions for the next inning.
8. It is optional by the manager or team captain to follow the defensive pattern of players for the teams batting order or create a separate batting line up sheet.
9. Each player is provided six pitches during the duration of their turn at bat. Assuming there is a neutral behind the plate (or behind the pitcher) umpire; the umpire will call balls, strikes and wild pitches. In ROTOBALL the home plate umpire calls balls, strikes and wild pitches, based upon the appearance of both a designated strike, ball and wild pitch zone. The batter walks after four balls and is out after three strikes, whichever comes first.
10. Within those six pitches if the batter receives two wild pitches outside both the strike and ball zones, they are given first base.
11. Within those six pitches if the batter receives two strikes, three balls and a wild pitch then a “CAB” (complete at bat) is declared, and the batter is provided with a seventh pitch, to determine the outcome of their turn at bat. If on the 7th pitch the ball is hit foul, it is considered a strike and the batter is out. If the 7th pitch is a strike, then the batter is out. If the 7th pitch is a ball, then the batter is awarded 1st base. If the 7th pitch is wild pitch, then the batter is awarded 2nd base.
12. It would be an optional rule, decided prior to the game; that if two consecutive batters receive a “CAB”, the second batter is called out for lack of aggression. However, if the third consecutive batter receives a “CAB”, they are put on base to compensate for the pitcher's lack of aggression. From that point on, each consecutive batter receiving a “CAB” would be subject to either alternatively being placed on first base or being called out; until the balance of entire battering order has made a batting appearance for that specific inning.
13. As in traditional baseball, the tag up fly rule applies.
14. The inning is over when the batting team either has made three outs or has gone through the nine-player rotation set for that inning regardless of outs. If a team is reduced to less than nine-player rotation, (example eight due to injury); the inning is over after the side of eight players have had their turn at bats. All runs earned during that inning by the at batting team, is reflected upon the score board.
If an “at bat” team has less than eight players eligible in their lineup, they can not win the game under the mercy rules.
16. The game is won after reviewing the score after the (suggested) 6-innings of play, (assuming that a 9-inning game, was not decided on at the onset of the game). If the score is tied, then the team that scored the most bases, is declared the winner. Singles or walks are 1 point, Doubles and hit by a pitch (that results in a double) is 2 points, a triple is 3 points and a homerun is 4 points. If at this point if the number of bases is a tied, then the team with the most at bats throughs the lineup wins, (batting through the entire 9-man batting rotation in an inning, before the mandatory rules end the inning).

### SPECIFIC RULES AND DEFINITIONS

### The Game:

The game is played for convenience, on a tradition baseball field. There is no shortage of fields within the neighborhoods in our cities. The nine fielding positions of baseball are also used for convenience (however managers or team captain can perform position shifts of the players, to enhance a specific defensive look). Each opposing team has their players numbered one through nine on BATTING LINE UP CARD (OFFENSE)/FIELDING POSITIONS 1ST INNING (DEFENSE) FIG. 1a. Any substitution of a player would be a substitution of that (specified) number. DEFENSIVE LINE UP SHEET WITH BRACKETS FIG. 4; is a diagram that would designate the pattern of rotation of each player, as the players position is changed each inning; (exampled here is a pattern called LEFT 8 ROTATION).

At the onset of the game, these players are conveniently listed in a BATTING LINEUP CARD FIG. 2a; showing their order in the batting line up and naming their starting fielding position. FIG. 3a shows their assigned infield and outfield positions, on a basic baseball diamond fielding lineup diagram for innings 1-6. Once the manager or team captain declares a rotation pattern, the team is required to maintain that pattern on each inning change throughout the course of the game. Examples of rotation patterns are seen in the attached FIGS. 4, 4a, 5, and 5a. It is to be noted, there is a potential fifty-four patterns mathematically available; even before the possibility of a manager or team captain inserting or maximizing extreme creativity.

It is to be noted that no named or creative rotation diagram, will allow any player to be rotated back into a defensive player position; that they have already played within that same game.

### The Ball:

The inventor wishes the ball to be used in each play of this game, to be at the choice of the team managers or team captains. There is no shortage of the vast variety of ball sizes and hardness that are used in sports. Balls in general come in a variety of sizes, materials and surface textures. The surface textures include smooth, dimpled and raised seamed. The inventor encourages the use of rubber Pinkies, rubber (blue) handballs, and/or any variety in size and hardness of either hard or softballs.

At the college and professional level of play, it is predictable that a standard baseball would be used for men's play; and a similar sized regulation softball for women. Based upon the ball, players will need corresponding baseball gloves (or no gloves) and bats to accommodate their choice(s).

### The Bat:

As stated above, the inventor encourages creative fun in choosing the ball. This will then dictate, what would be a reasonable corresponding bat. A Pinkie or handball might suggest the use of a bat similar to a broom handle or stickball bat. Predictably with other types of firmer and harder balls, this would suggest typical baseball style bats made out of metal or wood. The managers and team captains would be restricted to standard weights and measures of homemade and commercial bats. Bats specifically designed for baseball or softball, would not ever be recommended for Pinkies or handballs. However, at the lower skill levels play, where ROTOBALL rules might be less enforced; it is imaginable that bat requirements might not be followed as tightly, but mixing and matching bats would give unfair advantage to the team using the heavier bats and be barred.

### The Glove:

As stated above, the inventor encourages creative fun in choosing the ball. This will then dictate, what would be a reasonable corresponding glove. A Pinkie or handball might suggest that no glove is needed (but could still utilized by any player desiring to do so). Predictable, other types of firmer and harder balls; would suggest typical baseball or softball style gloves.

### The Pitch:

Based upon the type of ball being used, it should be optional how the pitch is thrown; in the manner of over or underhand. Convenience may dictate that teams who have a history with a specific ball, seek out other teams with like kind preferences in this style of pitching; in regard to competition.

Based upon the team's captains or manager decision, predictably rubber and (traditionally) hard balls will be thrown overhand and (traditionally) softballs underhand.

### Definition of an Inning:

An inning is defined as simply as, each offensive team having an opportunity to have their turns at bat, while the opposing team has their turn at defensive fielding.

The inning is over when the batting team either has made three outs or has gone through the nine-player rotation set for that inning, regardless of outs.

### Skill Levels:

ROTOBALL is being created, to be played and appreciated by all players young and old; skilled and unskilled. The skill levels of play would start with youngsters prior to little league age and extend into the realms of the college and the professional levels. Some optional rules at the lower skill levels, would be beneficial to playing the game; but may appear to not be valid or necessary at the higher levels, (but would still remain optional).

### Manager or Team Captain:

Is the person responsible for filling in BATTING LINE UP CARD (OFFENSE)/FIELDING POSITIONS 1ST INNING (DEFENSE) FIG. 1a.; DEFENSIVE LINE UP SHEET WITH BRACKETS FIG. 3a; and creating the rotation pattern exampled as or similar to FIG. 4, 4a. 5. or 5a. They are additionally responsible for compliance of the rotation patterns and all game rules.

They are also responsible for all strategies throughout the game, along with all substitutions.

Managers and team captains are allowed to participate in the game as players, by simply adding their names to the lineup sheets.

### ROTOBALL Defensive Numbering System of Infielders and Outfielders:

Traditional Baseball has a numbering system for each of the defensive players. Here are the numbers that correspond to each defensive position on the field: (1) Pitcher; (2) Catcher; (3) First Baseman (4) Second Baseman; (5) Third Baseman; (6) Shortstop; (7) Left Fielder; (8) Center Fielder; and (9) Right Fielder. ROTOBALL for purposes of convenience, utilizes the same number system and named player positions.

### The Catcher:

Depending upon the level of play, the equipment that the catcher is wearing is crucial to reasonable safety of the player. At all levels of play, the (temporary) one inning catcher; should have the option of playing defense, in an infielder stance or catcher stance; and be required to wear typical catcher protective gear, if reasonable safety standards need to be required.

### Umpiring the Game:

A neutral behind the plate or behind the pitcher umpire, will call balls, strikes and wild pitches. There will be a designated strike zone, a designated ball zone and a designated wild pitch zone.

The umpire will be in charge of officiating the game and has the powers stated within the rules to eject players from the game. They are responsible for seeing that the rotation pattern of both teams is adhered to through the course of the game, as they are provided copies of the lineup sheets.

### Wild Pitch:

Is a pitch called by the umpire that is both outside the strike and ball zones passing in the direction of home plate. There are additional references to wild pitches in the rules, that affect the game.

### Bases and Pitching Mound:

The bases in ROTOBALL for convenience purposes will be named and used identically as in traditional baseball or softball, known as first, second, third and home plate. Based upon the predetermined ball, (and possible the lower skill level of the players); the pitching mound may be adjusted accordingly to any agreeable distance.

Though it is predictable that defensive players to must adhere to their designated positions as baseman or outfielders; the manager or the team captain has the authority to put them into a defensive shift, to move players to desired locations on the field.

### Defensive Shift:

This is done when the manager or the team captain moves defensive player(s) into new spot(s) on the playing field, to take advantage for the probability; that the batter will hit the ball into that area. This can be randomly done, by moving players to one side of the field. It would appear as if the manager or team captain were overloading the defensive field of play.

Example: It is permissible to move the second baseman to higher position in the infield and insert the third baseman into the vacated opening created. However, it is not permissible to move the third baseman to the first base position and move the first baseman to third; to take advantage of the third baseman's superior defensive skills.

### At Bat:

Each player is provided six pitches during the duration of their turn at bat. Assuming there is a neutral behind the plate umpire, the umpire will call balls, strikes and wild pitches. In ROTOBALL the home plate umpire calls balls, strikes and wild pitches, based upon the appearance of both a designated strike, ball and wild pitch zone. The batter walks after four balls and is out after three strikes, whichever comes first.

Within those six pitches, if the batter receives two wild pitches outside both the strike and ball zones; they are given first base.

Within those six pitches if the batter receives two strikes, three balls and a wild pitch then a “CAB” (complete at bat) is declared, and the batter is provided with a seventh pitch, to determine the outcome of their turn at bat. If on the 7th pitch the ball is hit foul, it is considered a strike and the batter is out. If the 7th pitch is a strike, then the batter is out. If the 7th pitch is a ball, then the batter is awarded 1st base. If the 7th pitch is wild pitch, then the batter is awarded 2nd base.

### Hit by the Pitch:

If the batter is accidently hit by a pitch, the batter is awarded 2 bases (double). If the batter is intentionally hit by a pitch, the batter is awarded 4 bases (homerun); and the pitcher is ejected from the game; and an eligible substitute player is inserted into the pitcher's vacated position. If there is no eligible substitute player available at point in the game; the affected manager or team captain can ask the opposing manager or team captain permission to insert an ineligible player. If the opposing manager or team captain states “no”; the game is over and winner is declared by review of the scorecard.

Predictably, the manager or team captain will not say “no”, if they are behind on the scorecard. However, if this same manager or team captain has utilized this “advantage” in the past; the team will be disqualified regardless of the score, ending the game and taking the loss.

### Eligible Player:

All players listed by the manager or team are eligible at the beginning of the game. Except under unusual circumstances, when an officiating or governing party has ruled a specific player ineligible; due to previous player's conduct.

### Ineligible Player:

Is any player that has been deemed ineligible previously, by an officiating or governing party due to previous player's conduct.

For a player in ROTOBALL to be declared ineligible, they first must have eligibility at the onset of the game. No person or persons viewing the game from the sidelines or bleachers, can be declared eligible or ineligible.

In the flow of play in the game of ROTOBALL, a player can become ineligible under two separate events. The first is the event of the manager or team captain substitutes the player out of the game; for which they mandatorily cannot return. And secondarily, for conduct that is violation of the rules.

An ineligible player is a player that has already been substituted out of the game; due to a manager or team captain substitution, or a temporary injury. No ejected player can be re-inserted back into the game, within the rules of ROTOBALL, without special permission of the opposing manager or team captain.

### Reinstatement of an Ineligible Player:

There are times during a game of ROTOBALL, when a manager or team captain has exhausted their reserve bench players due to substitution or injury. If for any reason a manager or team captain needs to replace a player to bring their rooster back to nine active players; they can request permission from the opposing manager or team captain.

Based on other ROTOBALL rules, the game could possibly be called at this point. And the opposing manager or team captain can also decline the requesting manager or team captain's request; and require the requesting manager or team captain to play with less players or forfeit.

However, if the opposing manager or team captain is agreeable to allowing the requesting manager or team captain to reinsert an ineligible player; the requesting manager or team captain must present to the opposing manager or team captain with all currently able-bodied ineligible players. The opposing manager or team captain, will them name the ineligible player to be reinserted back into the game. If the requesting manager or team captain is not agreeable with the choice, they can act appropriately to other ROTOBALL rules in place.

### Eject(able) Behavior:

Ejected players, will be replaced by a substitute player assuming there is an eligible substitute player; otherwise, the manager or team captain can ask the opposing manager or team captain permission to inset an ineligible player. If the opposing manager or team captain says “no”, the violating team will be required to play with less defensive and offensive players.

EXAMPLE: The violating team will be reduced to 8 defensive players fielding and have an inning at bat of now 8. EXAMPLE: The pitcher is ejected for hitting a batter. The pitcher is than ejected and a substitute pitcher needs to be inserted. If there are no substitutes, the affected manager or team captain can ask the opposing manager or team captain to allow for an ineligible to be inserted under ROTOBALL stated rules. If the opposing manager or team captain refuses, the game can be called; under ROTOBALL stated rules.

(Optional): Any player that is ejected from a game (at the higher levels of play) can not be reinserted back into the team's line up for a period of 6-innings (which may make them ineligible for 1 (present game) or 2 (the next game). If any player is suspended, the terms and length of the suspension will take president. However, this suspension does not affect the manager or team captain from presenting a nine-player line up in any future or sequential game(s).

### Protective Equipment:

All players are encouraged to wear safety protective equipment. This equipment would vary at various levels of play and the hardness of the ball being used. Even at the lowest level of play the person rotating into the catcher's position, should wear a facemask to protect them from the onset of a ball or bat incident.

### Roster (Suggested):

The manager or team captain typically will field 9 players for each inning, regardless of the team's status of offense or defense play. An additional 5 players (suggested) could be available on the bench for purposes of substitution.

### Substitutions of Player:

The manager or team captain can substitute any player at any time during offensive or defensive play. The substituted “out player” is permanently removed from the game; and can only be replaced with an eligible player who has not been previously played. This substitution policy includes injured players, base runners, and batters (in the middle of their turn at bat).

### Winning the Game:

The game is won after reviewing the score after the (suggested) 6-innings of play, (assuming that a 9-inning game, was not decided on at the onset of the game). If the score is tied, then the team that scored the most bases, is declared the winner. Singles or walks are 1 point, Doubles and hit by a pitch (that results in a double) is 2 points, a triple is 3 points and a homerun is 4 points. If at this point if the number of bases is a tied, then the team with the most “at bat” throughs the lineup wins, (batting through the entire 9-man batting rotation in an inning, before mandatory rules end the inning).

### Mercy Rule:

It is optional at all levels of skill play, (but suggested at the lower skill levels play); that there be a mercy rule which ends the game prematurely, when one team seems to be overly matched against the other. The use of the mercy rule must be okayed prior to the start of the game by both teams.

The mercy rule comes into effect when one team goes through its entire 9 player offensive batting line twice, within two consecutive innings; without ending either inning with three outs. The game is ended; and the team is awarded the winner, regardless of the current score or which team was ahead on the scorecard.

### Unclear ROTOBALL Rules:

The inventor has attempted to lay out the general rules of ROTOBALL; and reserves the right to enhance and add more rules, to as he further develops the game. On any occasion when an issue of rules comes up, that the inventor has not foreseen; the participants should rely on the widely known rules that accompany the “ball” being played in the game. This is exampled by the games of traditional baseball or softball respectfully.

Any official rule enhancements or changes, must be approved by the inventor; as protected under this patent.

### Strategy:

Pitching is critical at all levels of play and especially at the higher levels of play. However, a manager or team captain must create and assign a personnel line up that incorporates the best elements of the total team's ability to play both defense and offense. Ideally a manager or team captain, may option to load up as many pitchers as possible onto the roster. However, this will limit other personnel; who would be to subject to questionable and unreasonable defensive play and offensive output. At lower levels of play, this would be less crucial, as fun would overwhelm the need for ingenious strategies.

ROTOBALL is further complicated in the decisions made in both the batting and fielding line ups strategies. ROTOBALL offers the manager or team captain, to either display their true genius or defer to just having fun and enjoying the game.

### Authority

The inventor grants all players, managers and team captains authorization to play ROTOBALL for the pure enjoy, that it brings to the player. However, the inventor mandates that any person(s), organization(s) or entities that receives any fee, sponsorship, endorsement or pays a player any compensation to play ROTOBALL; must seek authorization and licensing from the inventor. This includes and not limited to youth sport organizations (little league), High School/college athletics, and semi and professional sports.

### BRIEF DESCRIPTION OF DRAWINGS

FIG. 1. Prior Art. Traditional baseball field with four named bases (names inserted), nine named defensive player positions (names inserted) and (with traditional numbering system per player inserted).

FIG. 2. Prior Art. Blank form. LINE UP CARD. Inventor has inserted the title BATTING LINE UP CARD (offense) FIELDING POSITION 1ST INNING (defense).

FIG. 2a. Prior Art. Sample of FIG. 2 filled in, as it would be seen at game time.

FIG. 3. Prior Art. Blank form similar to FIG. 1, enhanced (copied/inspired) by a cut and paste of a similar PRIOR ART FORM available on internet in color. This document is labeled DEFENSIVE LINE UP SHEET WITH BRACKETS. This form allows for the writing in of each inning rotation change, by player; for each consecutive 6 innings. The form can also be modified for the addition of substitute player's names, as they are inserted into the game.

FIG. 3a. Prior Art. This is FIG. 3 filled in, based upon the diagram rotation of a rotation to be described later in FIG. 4 as LEFT 8 ROTATION.

FIG. 4. Sample rotation pattern (filled in from Prior Art, inspired from both FIGS. 1 and 3a.). This a diagram of LEFT 8 ROTATION.

Catcher moves to 3rd base.

3rd moves to shortstop.

Shortstop moves to 2nd.

2nd moves to 1st.

1st moves to right field.

Right field moves to center field.

Center field moves to left field.

Left field moves to pitcher.

Pitcher Moves to Catcher.

FIG. 4a. Sample rotation pattern (filled in from Prior Art, inspired from both FIGS. 1 and 3a.). This a diagram of RIGHT 8 ROTATION.

Catcher moves to 1st base.

1st moves to 2nd.

2nd moves to shortstop.

Shortstop moves to 3rd.

3rd moves to left field.

Left field moves to center field.

Center field moves to right field.

Right field moves to pitcher.

Pitcher moves to catcher.

FIG. 5. Sample rotation pattern (filled in from Prior Art, inspired from both FIGS. 1 and 3a.) This is a diagram of LEFT P ROTATION.

Catcher moves to pitcher.

Pitcher moves to 3rd.

3rd moves to shortstop.

Shortstop moves to 2nd.

2nd to 1st.

1st moves to right field.

Right field moves to center field.

Centerfield moves to right field.

Right field moves to catcher.

FIG. 5b. Sample rotation pattern (filled in from Prior Art, inspired from both FIGS. 1 and 3a.). This is a diagram of RIGHT P ROTATION.

Catcher moves to pitcher.

Pitcher moves to 1st.

1st moves to 2nd.

2nd moves to shortstop.

Shortstop moves to 3rd.

3rd moves to left field.

Left field moves to center field.

Center field moves to right field.

Right field moves to catcher.

FIG. 6. Hand drawing of Prior Art. Sampling of Balls. (handball, pinkie ball, baseball, softball).

FIG. 7. Hand drawing of Prior Art. Sampling of Bats. (stickball, baseball and softball).

FIG. 8. ROTOBALL batter at bat, (internet drawing with verbiage of strike zone, top of shoulder, midpoint, top of pants and hollow beneath kneecaps; modified by inventor showing the adding of both the ball and wild pitch zones). Diagram of FIG. 8 shows, the limitations of each of the pitching target zones, that are subjectively called by the home plate umpire as balls, strikes and wild pitches. Pitches that are called “strikes” are limited to the strike zone. Pitches that are called “balls” are limited to the ball zone. “Wild pitches” are baseballs thrown outside both that “ball” and “strike” zones. The figure does not show a boxed or enclosed rectangle for the wild pitch zone; as it is infinite in all directions, from the ground to the sky and from behind the batter to any distant parts of the playing field and beyond.

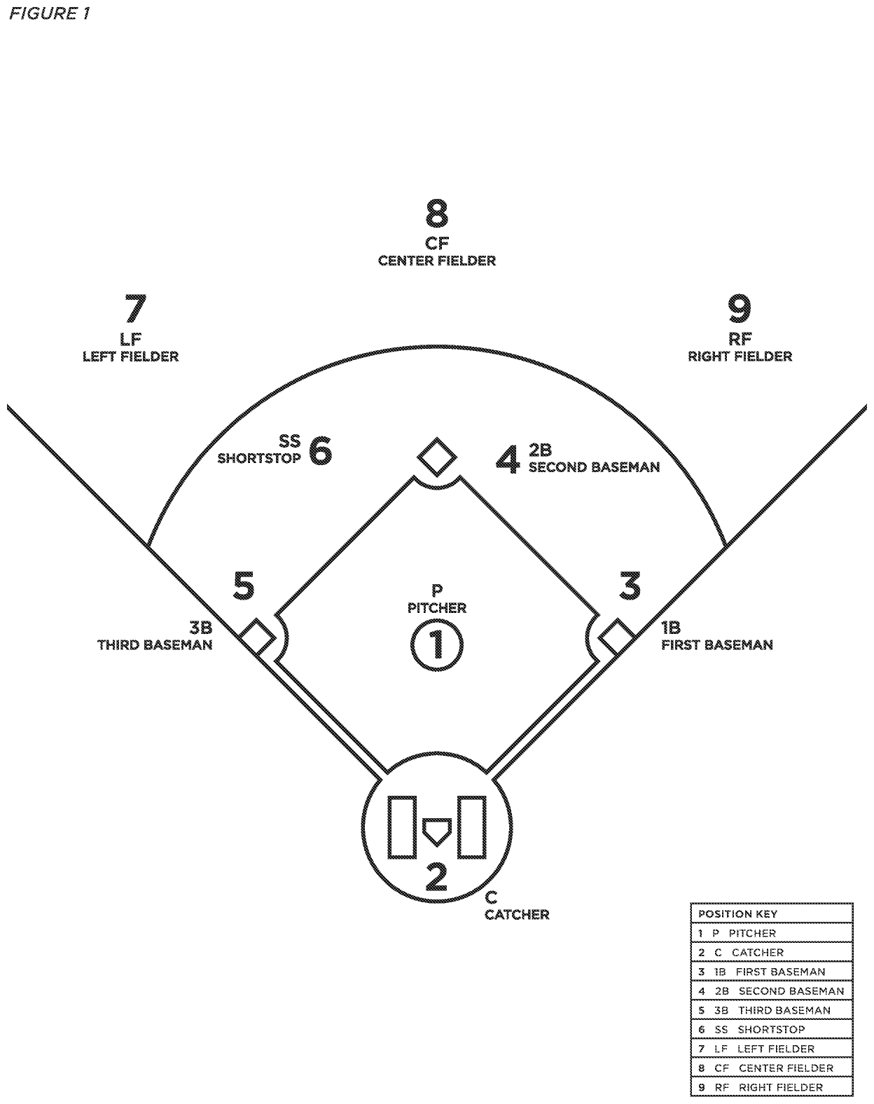

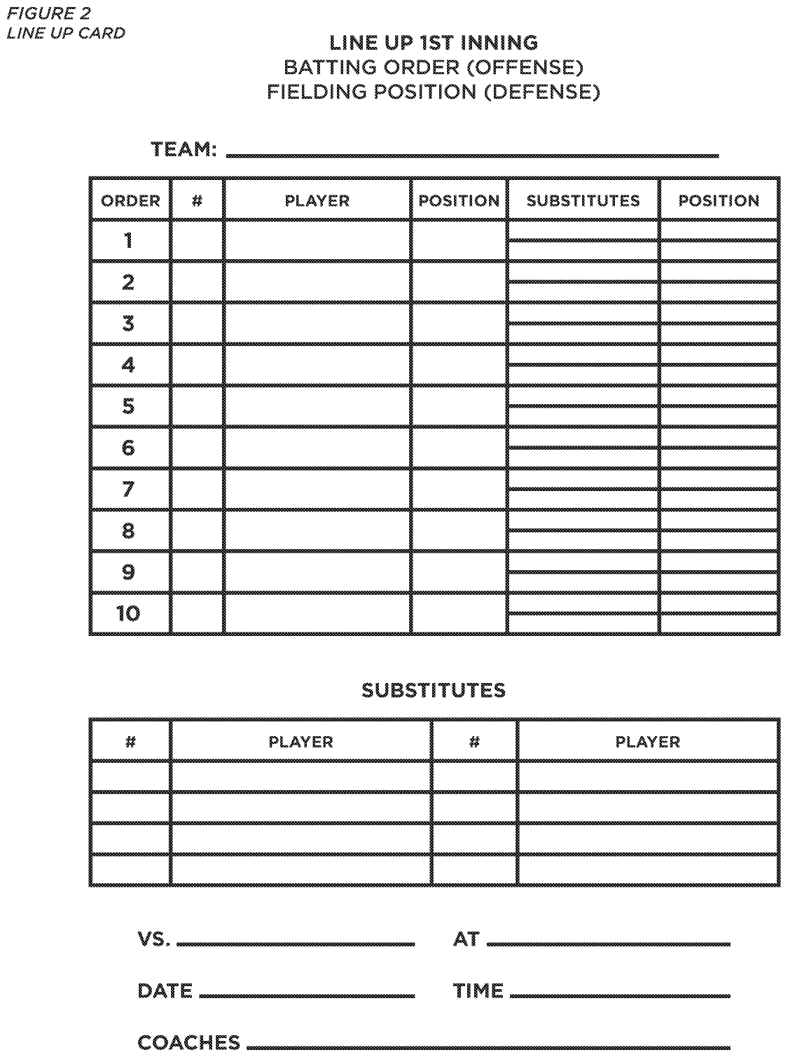

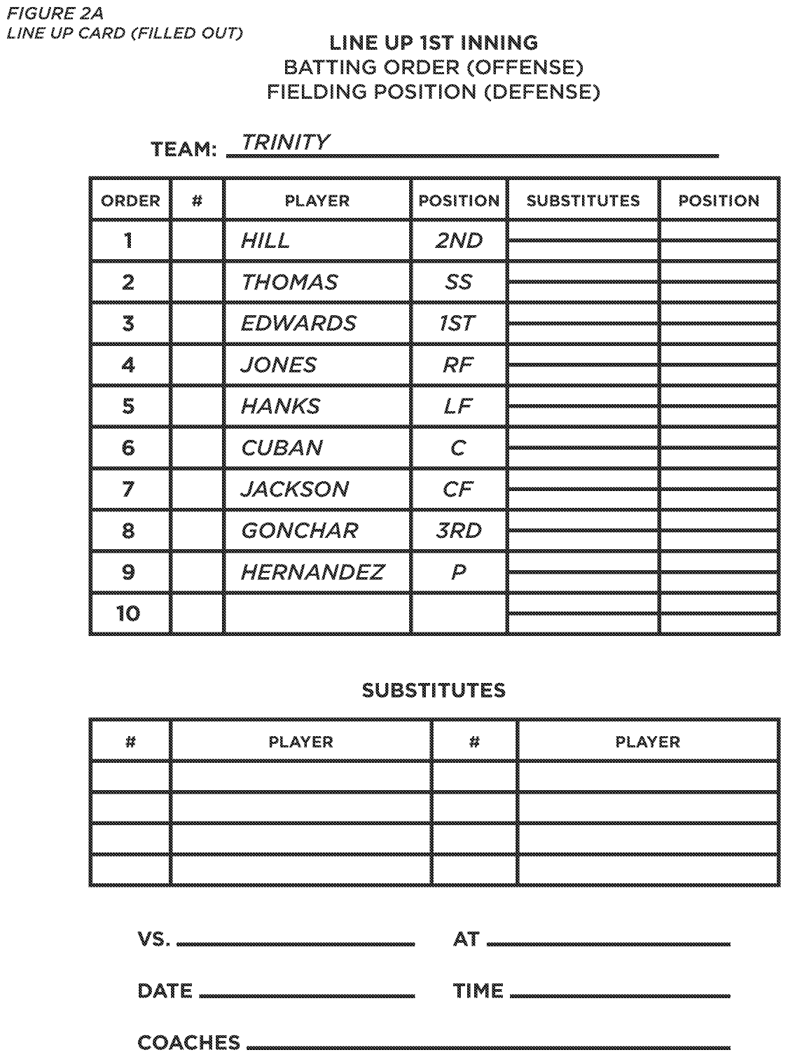

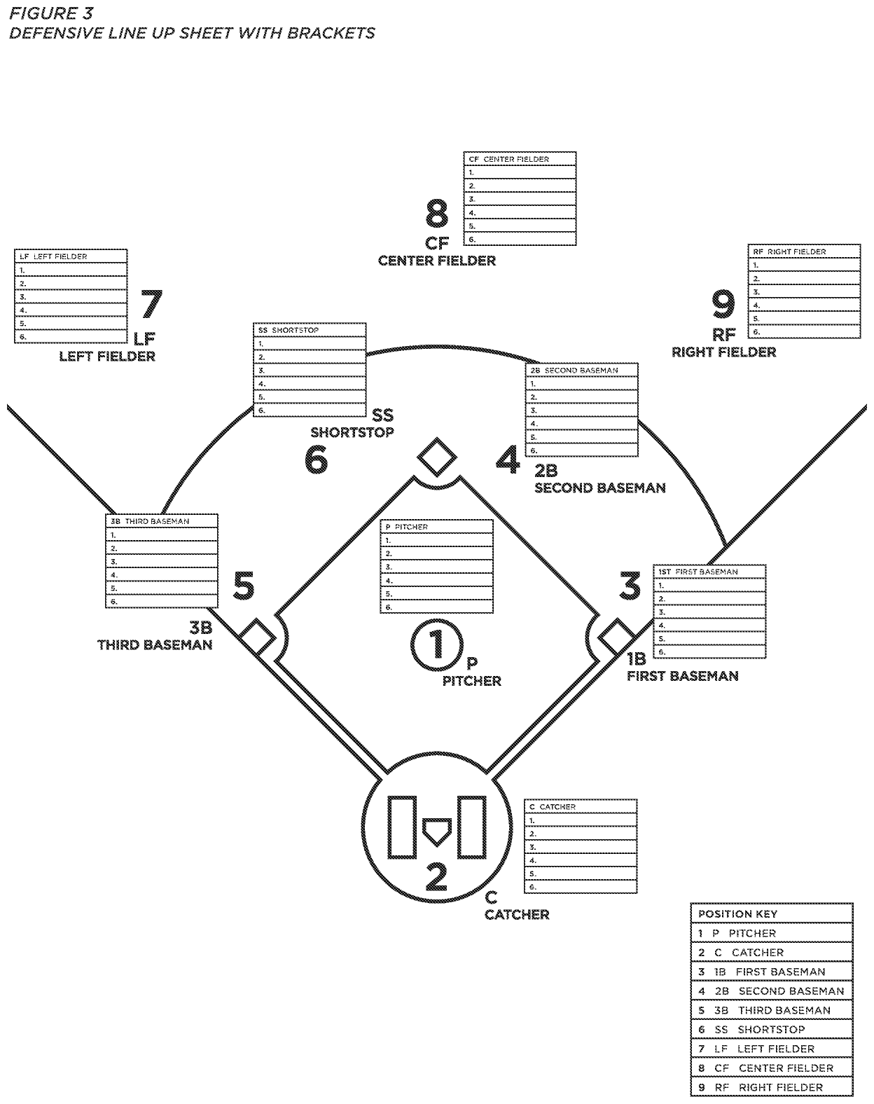

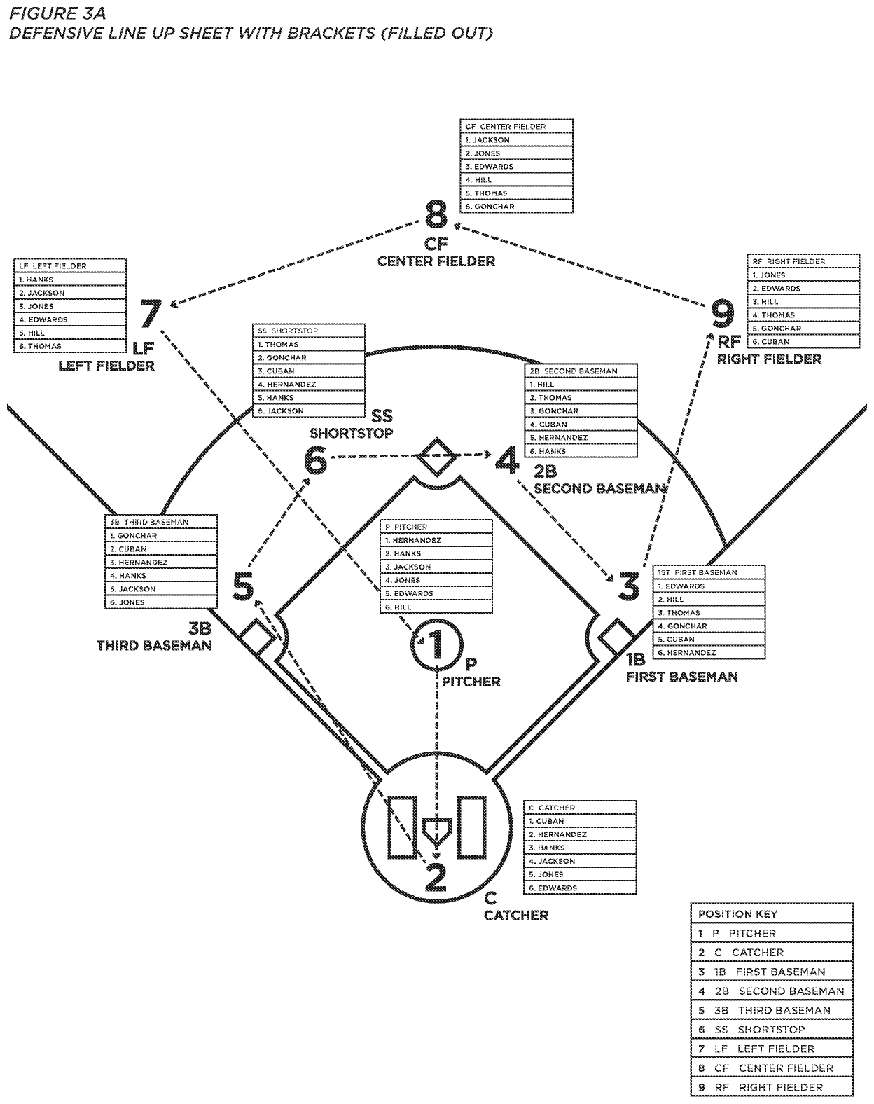

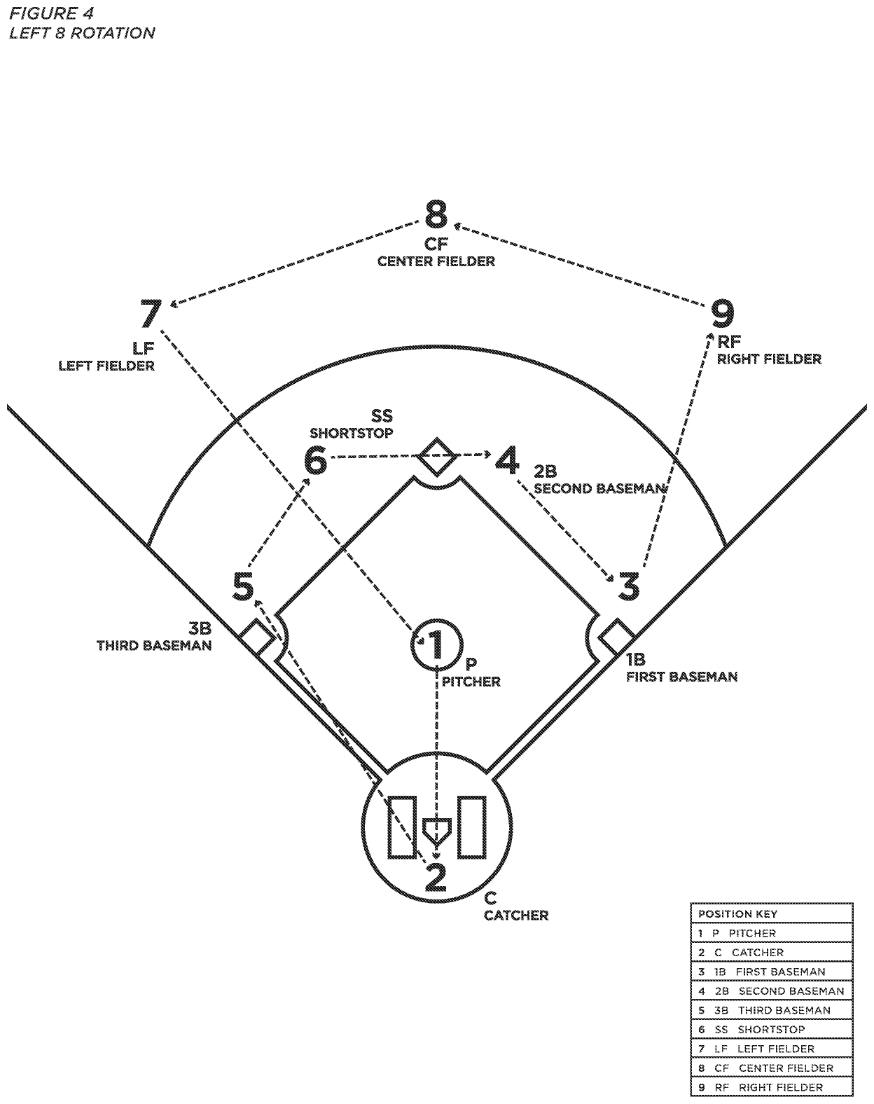

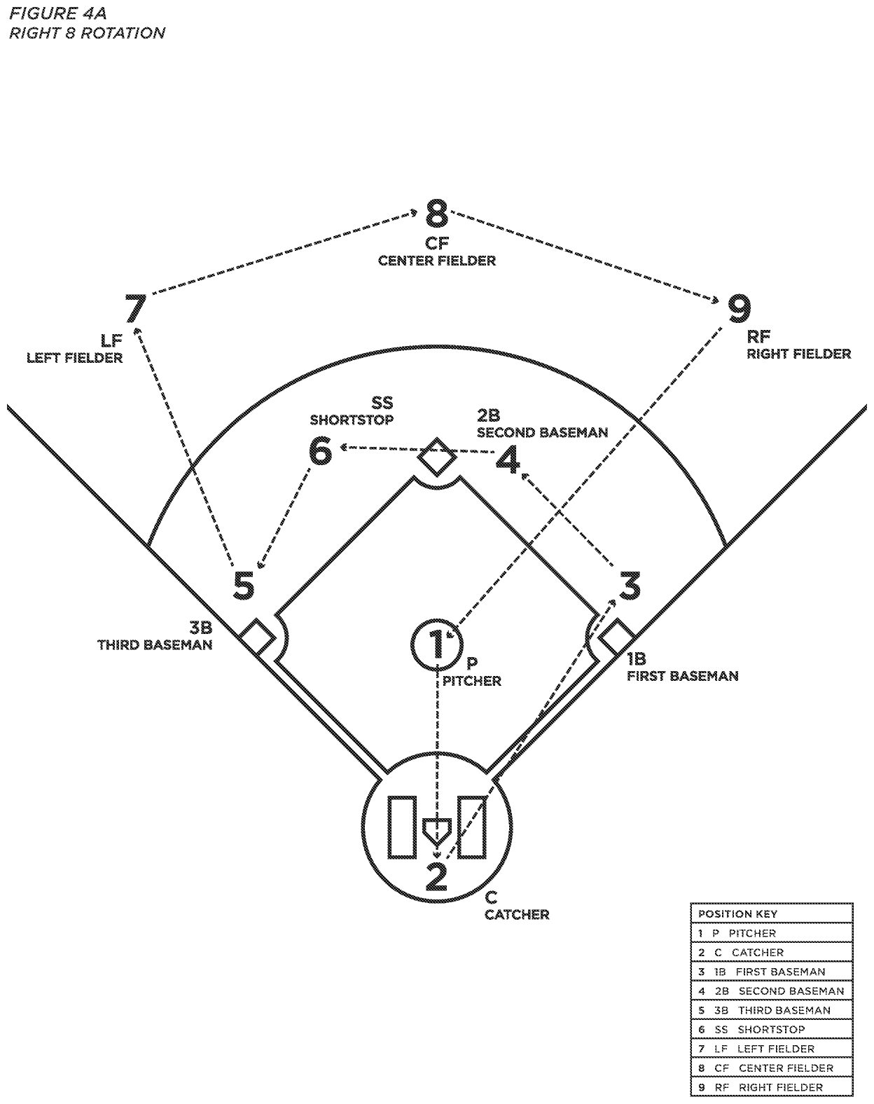

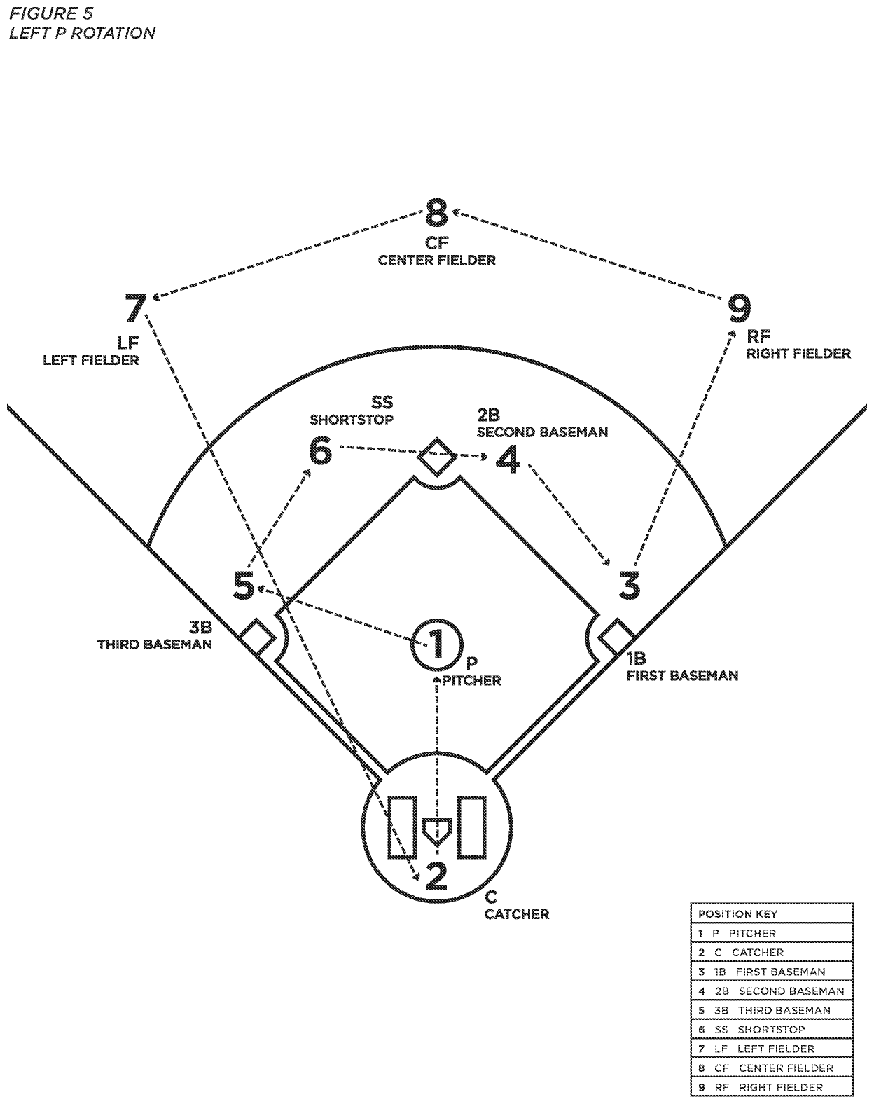

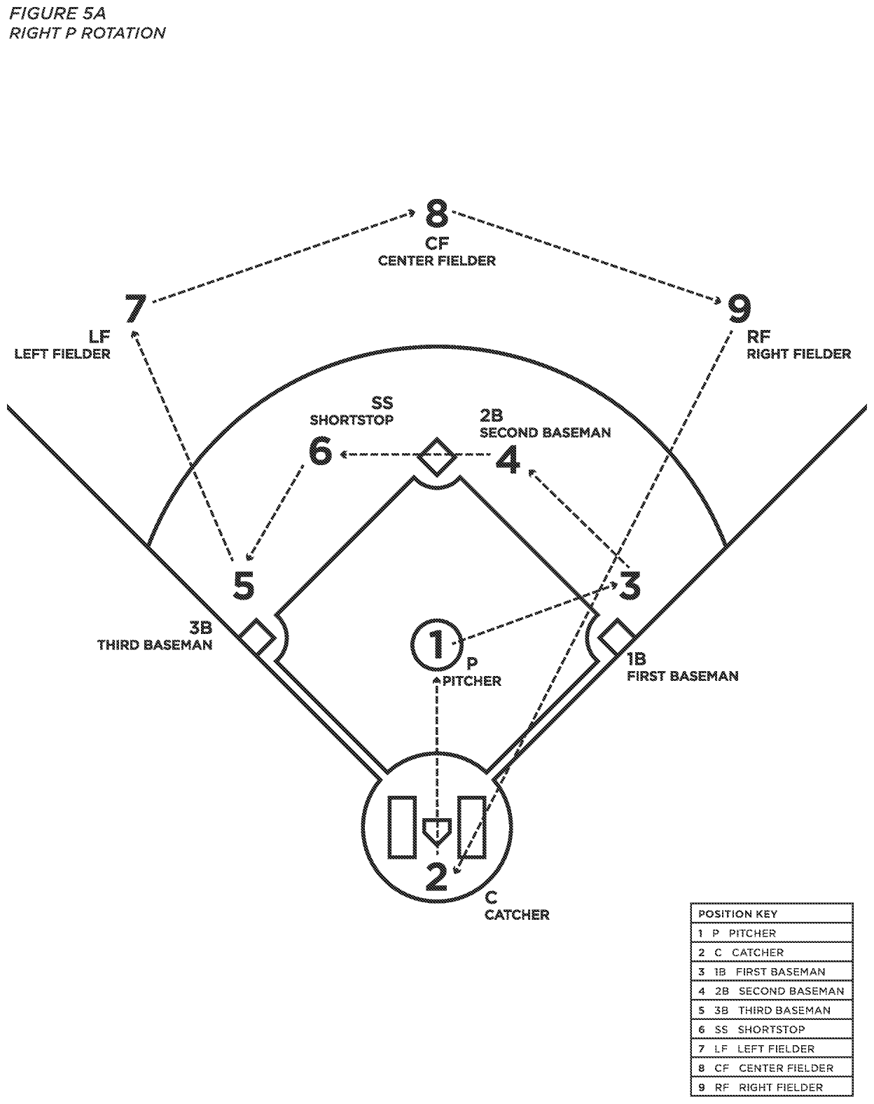

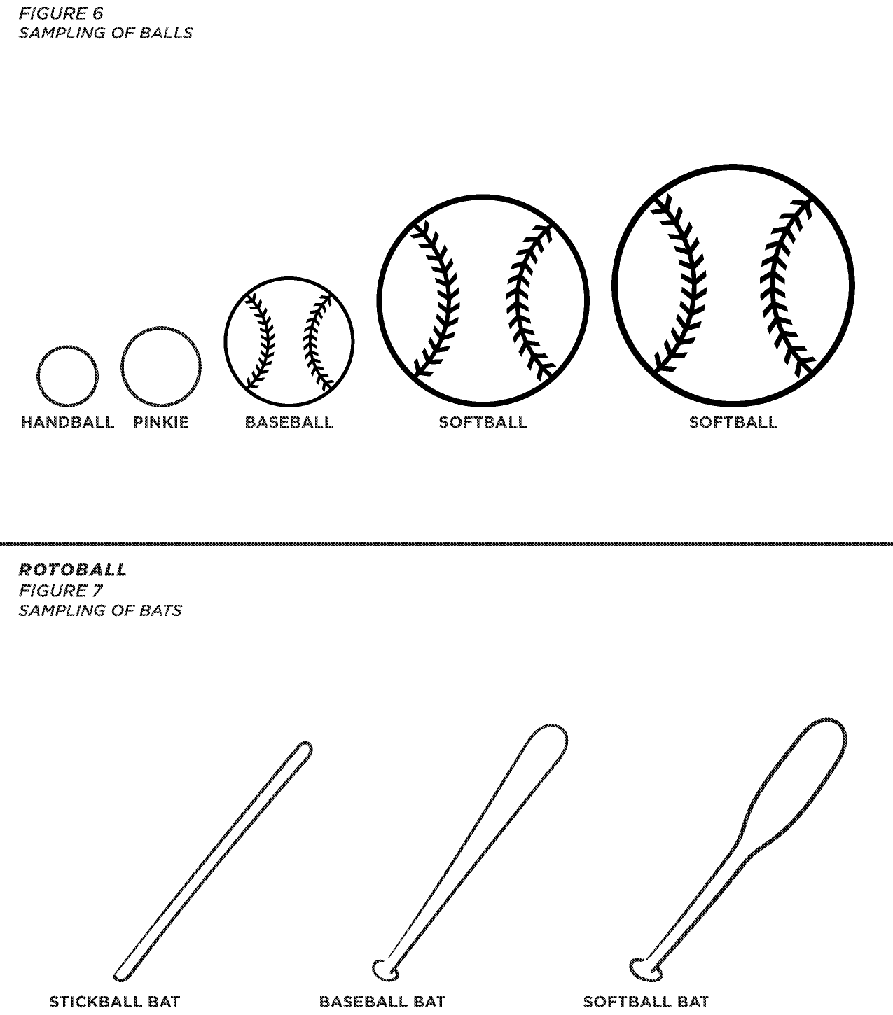

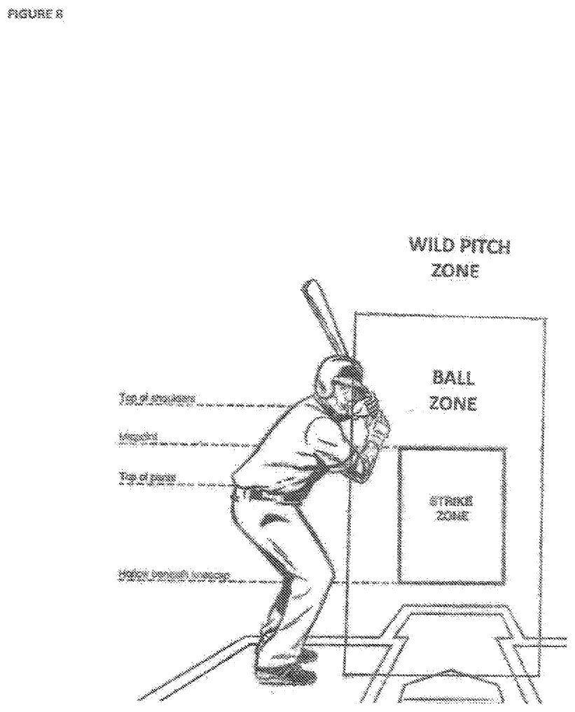

What is claimed:

1.-43. (canceled)

44. In the sport ball game of ROTOBALL there is a required element to the rules of the game that each of the nine defensive players must move into a different defensive position on the onset of each new consecutive innings in a predetermined rotation pattern.

45. In accordance with claim 44, the management of the process rotating each of the nine players must move into a different defensive position on the onset of each new inning in a predetermined rotation pattern is done with the aid of a defensive rotation device, whose sole function is to display the movement of both the infielders and outfielders in that same predetermined rotation pattern through the course of the game.

46. In accordance with claim 44, the basic component of the ROTOBALL defensive rotation device is a basic display of ball field showing the placement of all defensive positions with the embodiment of a design to add the names of each defensive players during the rotation of their defensive play over the course of the desired number of innings.

47. In accordance with claim 46, the device takes on the properties and solution of a functioning activated device when the team manager or team captain adds the defensive players names.

48. In accordance with claim 47, in the sport ball game of ROTOBALL once the defensive rotation device is activated it is ready to be exchanged by each of the teams and presented to the umpire for the officiating of the game.

49. In accordance with claim 44, once a rotation pattern is determined by the team manager or team captain and the players have been named in the sports ball game of ROTOBALL, the team manager or team captain can make substitutions to the defensive positions but cannot change the predetermined rotation pattern for the entirety of that game.

50. In accordance with claim 44, the team manager or team captain has the option to make substitutions on the defensive rotation lineup; by simply removing the old player's name and adding the new player's name for the innings that are applicable.

51. In accordance with claim 44, on the onset of a new inning no player(s) can be moved out of their rotated new position without being substituted out of the game.

52. In accordance with claim 44, however once a defensive player is substituted out of the game of ROTOBALL, the player cannot return without permission from the opposing team manager or team captain.

53. In accordance with claim 44, a typical game of ROTOBALL is 6 innings, but can be decided upon by both team managers and team captain prior to the onset of the game to last as long as nine innings; for which the ROTOBALL defensive rotation device will accommodate and display the placement of the players within their assigned defensive positions and the rotation that follows on the onset of each new inning.
